(19) United States
(12) Patent Application Publication
(10) Pub. No.: US 2014/0014731 A1
(43) Pub. Date: Jan. 16, 2014

(54) IN-MOLD SHAPING STRUCTURE FOR RADIO FREQUENCY IDENTIFICATION

(71) Applicant: SHENG-CHANG HUANG, KAOHSIUNG CITY (TW)

(72) Inventor: SHENG-CHANG HUANG, KAOHSIUNG CITY (TW)

(73) Assignees: SUPREME TECHNIC PACKAGE CO., LTD., KAOHSIUNG CITY (TW); SHENG-CHANG HUANG, KAOHSIUNG CITY (TW)

(21) Appl. No.: 13/550,455

(22) Filed: Jul. 16, 2012

(51) Int. Cl. G06K 19/077

(52) U.S. Cl. 235/492

(57) ABSTRACT

An in-mold shaping structure for radio frequency identification includes a substratum formed in advance. The substratum can be the same as or different from a plastic product in material and is a membrane, a sheet, a foam sheet or a composite plate, having its circumferential edge provided with positioning lugs for accurately combining the substratum with a plastic product. A radio frequency identification label is composed of a radio frequency identification chipset, an antenna and a gluey surface to be stuck to one side of the substratum for making a RFID label containing the substratum and the radio frequency identification label. A plastic product can be combined with the RFID label when shaped, letting the RFID label sheathed by the plastic product to avoid being destroyed. Thus, the RFID label can be attached to plastic products for enhancing the value of the plastic products.

### BACKGROUND OF THE INVENTION

1. Field of the Invention

This invention relates to an in-mold shaping structure for radio frequency identification, particularly to one having a substratum made in advance to be combined with a radio frequency identification label for manufacturing a RFID label whose circumferential edge is formed with a plurality of positioning lugs or positioning recessions. Thus, the REID label can be accurately combined with a plastic product and protected by the plastic product, able to be extensively applied to other articles that respectively need a radio frequency identification device for enhancing radio frequency identification function of articles.

2. Description of the Prior Art

For the present, devices of radio frequency identification, as disclosed in a Taiwan patent application No. 093127285, in a China patent application No. 2004100783559 and in a U.S. patent application Ser. No. 10/946,795, titled “Label to be attached on a plastic product formed in a mold and identifiable by a wireless detecting device”, were previously devised by the inventor of this invention. However, in these previous patent applications, a flexible circuit board is used as a basic material provided thereon with the radio frequency identification chip and the antenna of a radio frequency identification device. In this invention, the antenna structure of the previous patent applications is innovated to increase an induction area for elevating identification function and further, the basic material is strengthened in structure, and a gluey film layer and a bridging layer are originally employed for carrying out label shaping in a plastic mold that is provided with a radio frequency identification device, simplifying structure, enhancing an effect of identification and widening the range of application. Further, if the radio frequency identification device is to be attached to an article, it is obliged to implicate a problem whether or not high temperature will produce to destroy the radio frequency identification device when the article is being shaped. Furthermore, it is not easy to have a RFID label accurately combined with a plastic product. For instance, in a Taiwan patent application No. 200834429, titled “A manufacturing method of products attached with a RFID label in a mold”, it is found difficult to deposit a basic material label containing RFID into a plastic product-shaping mold and have the plastic product accurately combined with the basic material label when the plastic product is shaped in the mold.

This invention is devised to ameliorate the above-mentioned defects in use of the conventional radio frequency identification device.

### SUMMARY OF THE INVENTION

The objective of this invention is to offer an in-mold shaping structure for radio frequency identification to have a radio frequency identification device sheathed in each sort of article for preventing the radio frequency identification device from being destroyed. The radio frequency identification device of this invention can easily be combined with all varieties of articles that need to employ such a radio frequency identification device, able to elevate efficacy of radio frequency identification and value of articles.

The in-mold shaping structure for radio frequency identification in the present invention includes a substratum formed in advance. The substratum can be made by injection molding, blow molding, hollow body molding, vacuum molding, compression molding or knife mold rolling. The substratum can be the same as or different from a plastic product in material, having its circumferential edge formed with a plurality of positioning lugs.

The substratum of this invention can be a thin film, a sheet, foaming sheet or a composite sheet, completely matching the requirements of plastic products.

The substratum is combined with a radio frequency identification label that is composed of a radio frequency identification chipset, an antenna and a gluey surface. The radio frequency identification label is stuck to one side of the substratum by the gluey surface, or, if provided with no gluey surface, the radio frequency identification label can be combined with the substratum by gluey film, or by processing of high frequency wave or supersonic wave to make up a RFID label containing both the substratum and the radio frequency identification label.

The RFID label of this invention can be combined with a plastic product in a plastic product-shaping mold when the plastic product is shaped, and further the plastic product can also be formed with a plurality of positioning lugs on the circumferential side, enabling the plastic products to be widely applied to all sorts of articles that are provided with the radio frequency identification device.

### BRIEF DESCRIPTION OF DRAWINGS

This invention will be better understood by referring to the accompanying drawings, wherein:

FIG. 1 is a combination view of a RFID label in the present invention;

FIG. 2 is a cross-sectional view of a first preferred embodiment of the RFID label in the present invention;

FIG. 3 is a cross-sectional view of a second preferred embodiment of the RFID label in the present invention;

FIG. 4 is a front view of a third preferred embodiment of the RFID label in the present invention;

FIG. 5 is a front view of a fourth preferred embodiment of the RFID label in the present invention;

FIG. 6 is a front view of a fifth preferred embodiment of the RFID label in the present invention;

FIG. 7 is a front view of a sixth preferred embodiment of the RFID label in the present invention;

FIG. 8 is a front view of a seventh preferred embodiment of the RFID label in the present invention;

FIG. 9 are front views of a first preferred embodiment of the RFID label deposited in a plastic product-shaping mold and the RFID label combined with the plastic product after shaped in the present invention;

FIG. 10 is a cross-sectional view of a first preferred embodiment of a radio frequency identification product in the present invention;

FIG. 11 are front views of a second preferred embodiment of the RFID label put in a plastic product-shaping mold to have the RFID label combined with the plastic product after shaped in the present invention;

FIG. 12 are front views of a third preferred embodiment of the RFID label positioned in a plastic product-shaping mold to have the RFID label attached to the plastic product after shaped in the present invention;

FIG. 13 is a cross-sectional view of the third preferred embodiment of a radio frequency identification product in the present invention;

FIG. 14 is a front view of a fourth preferred embodiment of a radio frequency identification product in the present invention;

FIG. 15 is a front view of a fifth preferred embodiment of a radio frequency identification product in the present invention;

FIG. 16 is a front view of a sixth preferred embodiment of a radio frequency identification product in the present invention;

FIG. 17 is a cross-sectional and exploded view of a seventh preferred embodiment of a radio frequency identification product in the present invention;

FIG. 18 is a cross-sectional view of a eighth preferred embodiment of a radio frequency identification product in the present invention; and

FIG. 19 is a front view of the radio frequency identification product attached to every sort of commercial product in the present invention.

### DETAILED DESCRIPTION OF THE PREFERRED EMBODIMENT

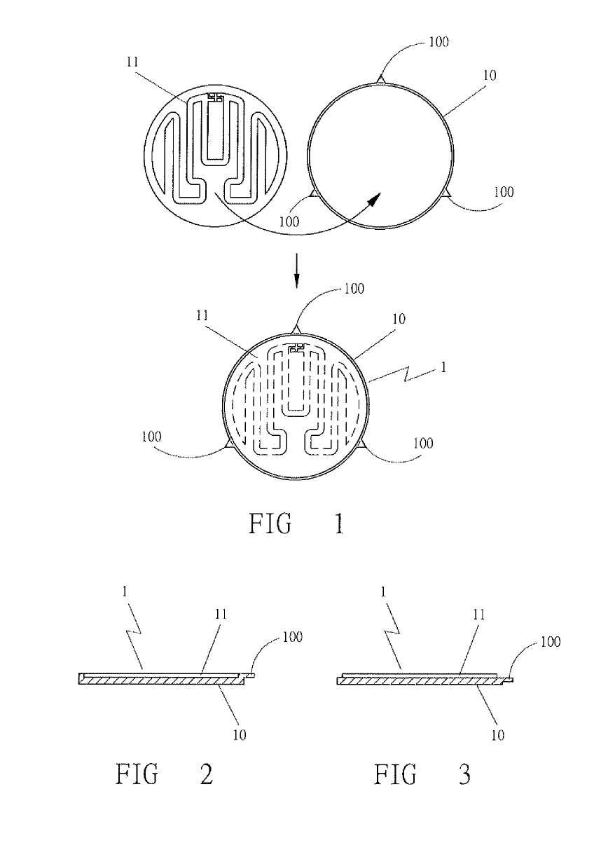

A preferred embodiment of a RFID label 1 in the present invention, as shown in FIG. 1 at least includes a substratum 10 and a radio frequency identification label 11.

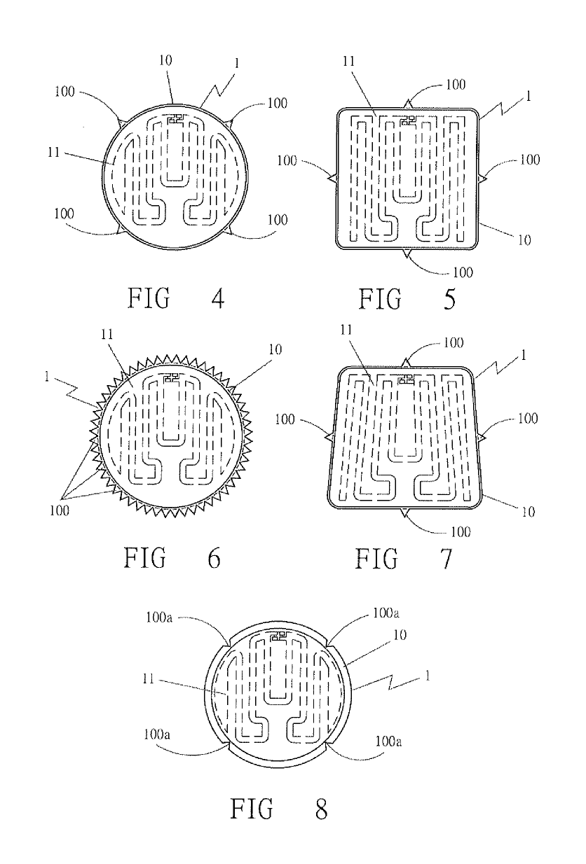

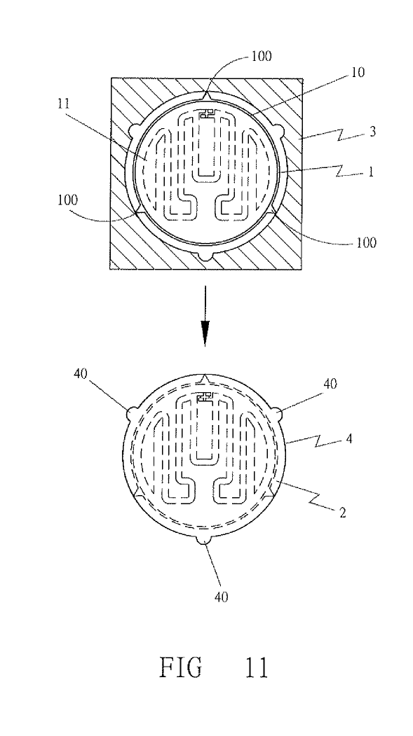

The substratum 10 is made in advance by injection molding, blow molding, hollow body molding vacuum molding, compression molding or knife mold rolling, and the substratum 10 can be the same as or different from the material of every sort of products to be combined with. The substratum 10 can be made into a membrane, a sheet, a foaming sheet or a composite plate, completely matching with requirements of plastic products. Further, the substratum 10 has its circumferential edge provided with a plurality of positioning lugs 100 or positioning recessions 100a, as shown in FIGS. 2-8.

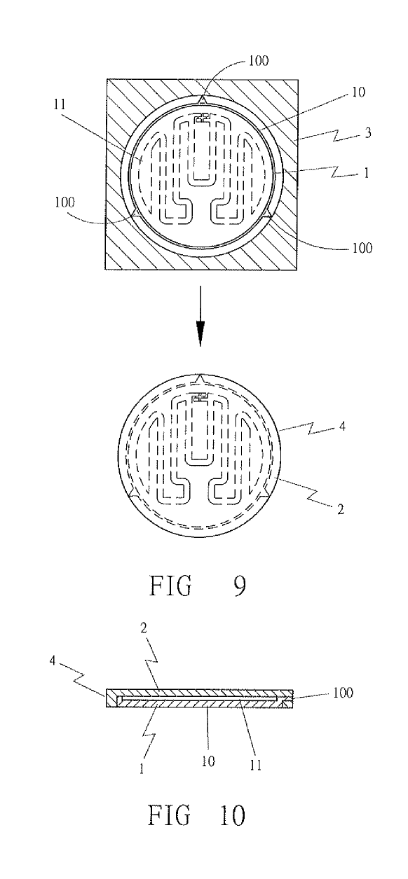

The radio frequency identification label 11 to be attached to one side of the substratum 10 is provided with a radio frequency identification chipset, an antenna and a gluey surface, and the radio frequency identification label 11 is stuck to one side of the substratum 10 by the gluey surface. If no gluey surface is provided, the radio frequency identification label 11 can be attached to one side of the substratum 10 by a gluey film, or by processing of high frequency wave or supersonic wave. The radio frequency identification label 11 is composed of a radio frequency identification chipset, an antenna and a circuit board. The RFID label 1 can be made into any shape, such as a round shape shown in FIGS. 4, 6 and 8, a rectangular shape shown in FIG. 5, a trapezoid shape shown in FIG. 7, a triangular shape, a square shape or various irregular geometric shapes, and, of course, the RFID label 1 of any shape must be provide with foresaid positioning lugs 100 or positioning recessions 100a.

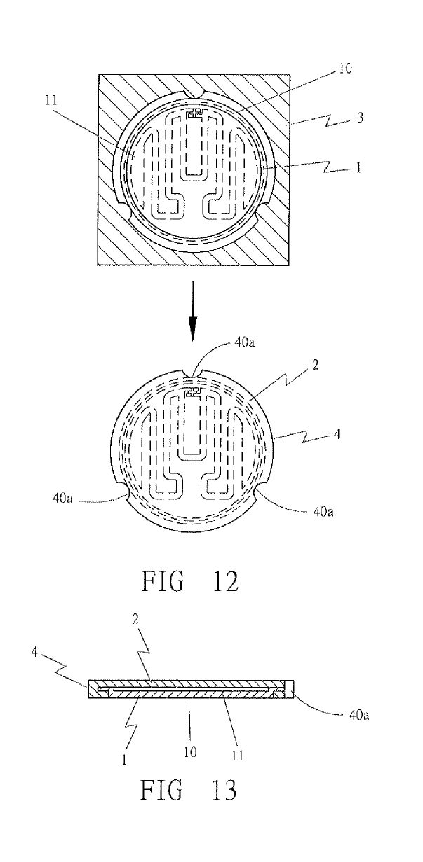

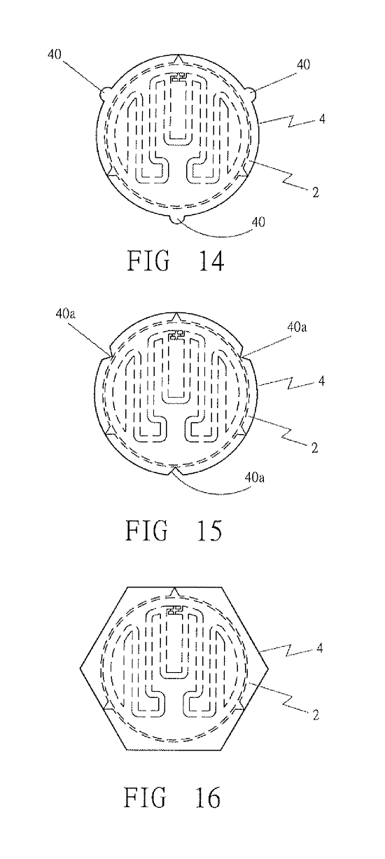

Next, referring to FIGS. 9, 11 and 12, the RFID label 1 is deposited in a mold 3 of a plastic product 2 to let the positioning lugs 100 or the poisoning recessions 100a touch the inner wall of the mold cavity and have the RFID label 1 accurately positioned in the cavity of the mold 3. When the plastic product 2 is shaped, the RFID label 1 will simultaneously be combined together with the plastic product 2 to make up an integrated radio frequency identification product 4, as shown in FIGS. 10, 11 and 13-16, thus, able to solve the vexation that RFID 1 is impossible to be accurately fixed in a mold 3. Although a RFID label 1 without being fixed in a mold still can be combined with a plastic product 2, yet the RFID label 1 of the radio frequency identification product 4 cannot accurately be combined with the plastic product 2; accordingly the RFID label 1 will deflect aside, resulting in difficulty in sequent use. Further, if the RFID label 1 of the radio frequency identification product 4 needs to be perforated with a hole, the radio frequency identification label 11 of the RFID label 1 will frequently be damaged.

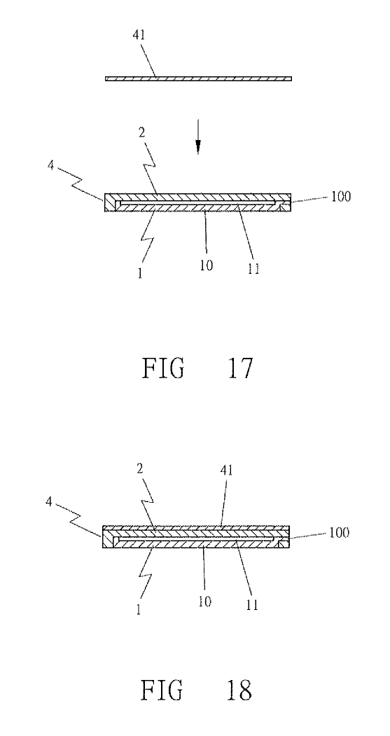

The radio frequency identification product 4 can be provided with no positioning lugs or positioning recessions on its circumferential edge, as shown in FIGS. 10 and 16, or provided with positioning lugs 40, as shown in FIGS. 11 and 14, or provided with positioning recessions 40a, as shown in FIGS. 13 and 15, either of the designs will do. The radio frequency identification product 4 can be accurately deposited in a shaping mold of such finished products as a mobile phone shell, a pallet or a bottle by means of the positioning lugs 40 and the positioning recessions 40a. Thus, when every sort of products is shaped in the mold, the radio frequency identification products 4 will be sheathed in the interior of such finished products.

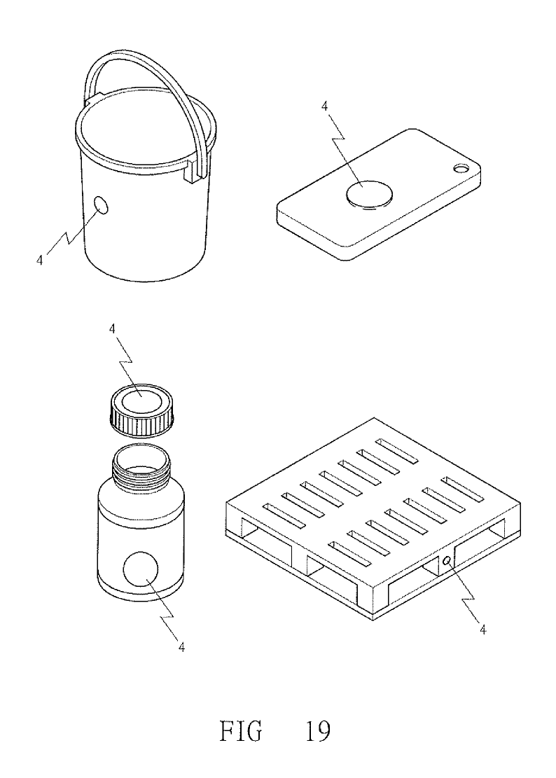

Apart from having the circumferential edge of the radio frequency identification product 4 disposed with positioning lugs or positioning recessions, for enabling the radio frequency identification product 4 to be firmly combined with finished products that are made of different materials, as shown in FIG. 19, the radio frequency identification product 4 has its surface formed with a layer of gluey film or membrane 41 via coating, adhering or other combination modes, as shown in FIGS. 17 and 18. The gluey film or the membrane 41 can be the same as or different from the substratum 10 of the RFID label 1 or the plastic product 2 in material and if in a different condition, then the gluey film or the membrane 41 must be made of a material the same as that of each sort of finished products, such a mobile phone shell or a pallet or a bottle, as shown in FIG. 19. Thus, the radio frequency identification product 4 can be accurately positioned in a shaping mold of the mobile phone shell, of the pallet, or of the bottle by means of the positioning lugs 40 or the positioning recessions 40a of the radio frequency identification product 4. After foresaid each sort of products is shaped, the radio frequency identification product 4 can be combined together with such finished products by the gluey film or the membrane 41 that are made of the same material as that of each sort of finished product, needless to depend on other media for carrying out combination.

If manufacturers of all kinds of finished products prepare to have each sort of products provided therein with a radio frequency identification device, all they have to do is purchase the radio frequency identification product 4 of this invention, and they can overcome difficulty in how to employ radio frequency identification for each sort of commercial product. To sum up, this invention is able to enhance convenience and practicability in identification management of all sorts of commercial products for attaining function and effect of complete identification, elevating application of radio frequency identification and increasing value of commercial products.

While the preferred embodiments of the invention have been described above, it will be recognized and understood that various modifications may be made therein and the appended claims are intended to cover all such modifications that may fall within the spirit and scope of the invention.

What is claimed is:

1. An in-mold shaping structure for radio frequency identification at least comprising:
a RFID label provided with a substratum, said substratum being the same as or different from a plastic product in material, said substratum being a membrane or a sheet or a foam sheet or a composite plate, said substratum having circumferential edge provided with a plurality of positioning lugs or positioning recessions, letting said substratum accurately combined with a plastic product, said RFID label disposed with a radio frequency identification label composed of a radio frequency identification chipset, an antenna and a circuit board, said radio frequency identification label provided with a gluey surface, said radio frequency identification label attached to one side of said substratum via said gluey surface to make said RFID label; and
a plastic product in a shaping mold, said RFID label positioned in said shaping mold of the plastic product, said RFID label sheathed by the plastic product when the plastic product is shaped in said shaping mold, said RFID label able to be accurately combined with said plastic product to make up a radio frequency identification product to be employed more conveniently.

2. The in-mold shaping structure for radio frequency identification as claimed in claim 1, wherein said RFID label can be made into any shape.

3. The in-mold shaping structure for radio frequency identification as claimed in claim 1, wherein said RFID label can be accurately combined with the cavity of said shaping mold of plastic products by said positioning lugs or positioning recessions of said RFID label.

4. The in-mold shaping structure for radio frequency identification as claimed in claim 1, wherein said radio frequency identification product has circumference provided with positioning lugs or positioning recessions.

5. The in-mold shaping structure for radio frequency identification as claimed in claim 4, wherein said radio frequency identification product is formed with said positioning lugs or said positioning recessions to enable said radio frequency identification product to be accurately fixed in the cavity of said shaping mold of each sort of finished products, said radio frequency identification product sheathed in said finished products when they are shaped.

6. An in-mold shaping structure for radio frequency identification at least comprising:
a RFID label provided with a substratum, said substratum being the same as or different from plastic products in material, said substratum being a membrane, a sheet, a foam sheet or a composite plate, said substratum having circumferential edge provided with a plurality of positioning lugs or positioning recessions, letting said substratum accurately combined with a plastic product, said RFID label provided with a radio frequency identification label, said radio frequency identification label composed of a radio frequency identification chipset, an antenna and a circuit board, said radio frequency identification label formed with a gluey surface, said radio frequency identification label attached to one side of said substratum by said gluey surface to make up said RFID label.

7. An in-mold structure for radio frequency identification at least comprising:
a RFID label disposed with a substratum, said substratum being the same as or different from a plastic product in material, said substratum being a membrane, a sheet, a foam sheet or a composite plate, said substratum having circumferential edge formed with a plurality of positioning lugs or positioning recessions, said positioning lugs enabling said substratum to be accurately combined with a plastic product, said RFID label provided with a radio frequency identification label, said radio frequency identification label composed of a radio frequency identification chipset, an antenna and a circuit board, said radio frequency identification label formed with a gluey surface to be attached to one side of said substratum for making said RFID label; and
a plastic product provided with a gluey film or a membrane, said RFID label positioned in a plastic product-shaping mold, said RFID label sheathed by the plastic product when said plastic product is shaped in said shaping mold, said RFID label able to be accurately combined with said plastic product to make a radio frequency identification product, which can be employed with great convenience.

8. The in-mold shaping structure for radio frequency identification as claimed in claim 7, wherein said RFID label can be made into any shape.

9. The in-mold shaping structure for radio frequency identification as claimed in claim 7, wherein said RFID label can be accurately combined with the cavity of said plastic product-shaping mold via said positioning lugs or said positioning recessions of said RFID label.

10. The in-mold shaping structure for radio frequency identification as claimed in claim 7, wherein said radio frequency identification product has circumference formed with positioning lugs or positioning recessions.

11. The in-mold shaping structure for radio frequency identification as claimed in claim 10, wherein said radio frequency identification product is provided with said positioning lugs or said positioning recessions to enable said radio frequency identification product to be accurately positioned in a shaping mold of each sort of finished products, said radio frequency identification product sheathed by each sort of finished products when said finished product is shaped.
